(19) United States
(12) Patent Application Publication
(10) Pub. No.: US 2015/0066672 A1
(43) Pub. Date: Mar. 5, 2015

(54) METHOD AND APPARATUS FOR PROVIDING ONLINE CONTENT MANAGEMENT AND E-COMMERCE SOLUTION

(71) Applicant: Verizon Patent and Licensing Inc., Basking Ridge, NJ (US)

(72) Inventors: Shivakumar Swamynathan, Wesley Chapel, FL (US); Narayana Guduru, Tampa, FL (US)

(73) Assignee: Verizon Patent and Licensing Inc., Basking Ridge, NJ (US)

(21) Appl. No.: 14/015,237

(22) Filed: Aug. 30, 2013

(51) Int. Cl. G06Q 30/06

(52) U.S. Cl. CPC G06Q 30/0603
USPC 705/26.1

(57) ABSTRACT

An approach is provided for providing an online product catalog framework that enables a business to manage and deploy up-to-date and personalized products and/or services to customers using cross-channel commerce without dependency on IT specialists or IT releases, including providing an online product catalog framework, wherein the online product catalog framework includes a catalog management module, a pricing engine, a content management module, and a profile management module; managing the catalog and content modules and pricing engine separately; and generating a personalized product catalog by using rules-based targeters and/or rules-based templates along with the modules and/or pricing engine. The approach also including determining pricing data based on customer sales zones and determining one or more data feeds based on a product catalog system, wherein the pricing engine causes a generation of the personalized product catalog based on the pricing data, the one or more data feeds, or a combination thereof.

### BACKGROUND INFORMATION

Services providers are constantly developing new products and/or services as well as updating and improving their existing lines to keep up-to-date with market forces and to better meet the needs of customers. More specifically, today's consumers frequently desire products, services, and/or solutions that work across different device types (e.g., desktop personal computers and mobile devices) and/or media types (e.g., websites, mobile applications, social networking services, etc.). An increasingly popular and efficient way to offer such products and/or services to consumers is to make them available online (e.g., an e-commerce portal). Because the particular needs of consumers may vary depending on their quantity or size (e.g., an individual vs. a small business (SMB) vs. a large-scale enterprise), service providers often categorize their products and/or services online by customer type and such products and/or services are usually advertised with descriptive information such as written and visual media (e.g., photographs, videos, etc.), prices, offers or promotions, etc. However, some current solutions lack scalable product catalogs that can be easily modified by a business (e.g., a broadband and telecommunications provider) to meet the particular needs of various customers without dependency upon information technology (IT) specialists or IT releases, which may be costly and inefficient.

Based on the foregoing, there is a need for an approach providing an online product catalog framework that enables a business to manage and deploy up-to-date and personalized products and/or services to customers using cross-channel commerce (e.g., a webpage, a retail store, mobile devices, social media, call centers, etc.) without dependency on IT specialists or IT releases (i.e., a self-service solution).

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of providing an online product catalog framework that enables a business to manage and deploy up-to-date and personalized products and/or services to customers using cross-channel commerce without dependency on IT specialists or IT releases, according to one embodiment;

FIG. 2 is a diagram of the high-level architecture for learn and support content functionalities of the system, according to one embodiment;

FIG. 3 is a diagram of the high-level architecture for ordering, according to one embodiment;

FIG. 4 is a diagram of the system software architecture that can be used to implement an embodiment of the invention;

FIG. 5 is a diagram of the components of a product catalog platform, according to one embodiment;

FIG. 6 is a diagram of the system cross-channel architecture that can be used to implement an embodiment of the invention;

FIG. 7 is a diagram of a content management module, according to one embodiment;

FIG. 8 is a diagram of a hierarchy of a product catalog, according to one embodiment;

FIG. 9 is a diagram of a hierarchy of a product catalog category, according to one embodiment;

FIG. 10 is a diagram of a high-level architecture of the pricing engine, according to one embodiment;

FIG. 11 is a diagram of a pricing engine module, according to one embodiment;

FIG. 12 is a diagram of a high-level system hardware layout, according to one embodiment;

FIG. 13 is a diagram of the system hardware layout in detail that can be used to implement an embodiment of the invention;

FIGS. 14-17 are flowcharts of processes for providing an online product catalog framework that enables a business to manage and deploy up-to-date and personalized products and/or services to customers using cross-channel commerce without dependency on IT specialists or IT releases, according to one embodiment;

FIG. 18 is a diagram of a computer system that can be used to implement various exemplary embodiments of the invention; and

FIG. 19 is a diagram of a chip set that can be used to implement various exemplary embodiments of the invention.

### DESCRIPTION OF THE PREFERRED EMBODIMENT

An apparatus, method, and software for providing an online product catalog framework that enables a business to manage and deploy up-to-date and personalized products and/or services to customers using cross-channel commerce without dependency on IT specialists or IT releases are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

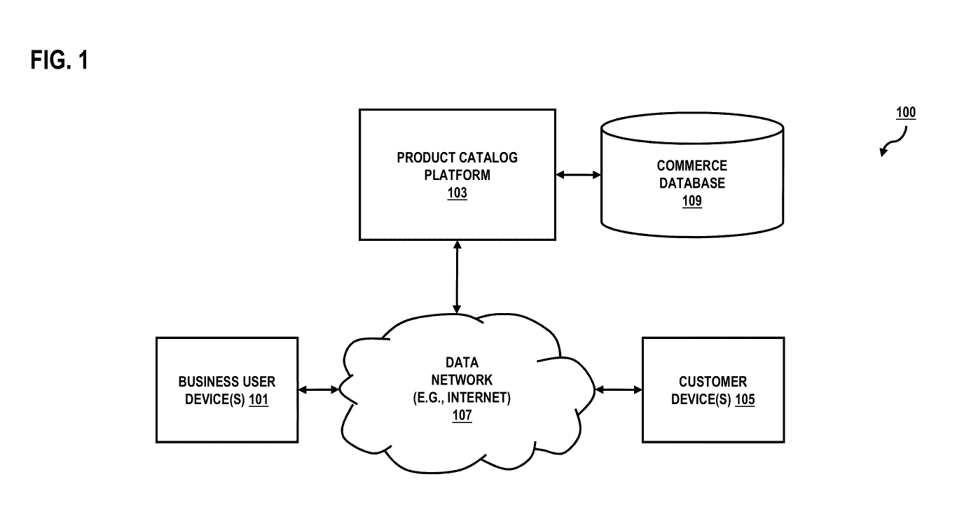

FIG. 1 is a diagram of a system capable of providing an online product catalog framework that enables a business to manage and deploy up-to-date and personalized products and/or services to customers using cross-channel commerce without dependency on IT specialists or IT releases. As previously discussed, services providers are constantly developing new products and/or services as well as updating and improving their existing lines to keep up-to-date with market forces and to better meet the needs of customers. In particular, today's consumers increasingly desire products, services, and/or solutions that work and/or are available across a wide-variety of device types (e.g., desktop personal computers and mobile devices) and/or media types (e.g., websites, mobile applications, social networking services, etc.). An increasingly popular and efficient way to offer such products and/or services to consumers is to make them available online. Because the particular needs of consumers may vary depending on their quantity or size, service providers often categorize their products and/or services online by customer type and the products and/or services often include descriptive information such as written and visual media, prices, offers or promotions, etc.

However, some current solutions lack scalable product catalogs that can be easily modified to meet the particular needs of various customers. The same is generally true for the associated software and requisite hardware. Moreover, because product catalog management, pricing, and content management functionalities are often lumped together, service providers are frequently unable to efficiently offer customers a personalized experience when viewing and/or interacting with a business' website. Further, without the benefit of rules-based targeters, rules-based templates, rules-driven tables, and the like, service providers often require the help and support of IT specialists or IT releases to meet the particular needs of the various customers, which may be costly and inefficient.

To address this problem, a system 100 of FIG. 1 introduces the capability to provide an online product catalog framework that enables a business to manage and deploy up-to-date and personalized products and/or services to customers using cross-channel commerce without dependency on IT specialists or IT releases, according to one embodiment. For the purpose of illustration, the system 100 that enables a business user (e.g., an administrator) to manage and deploy up-to-date and personalized products and/or services to customers using one or more business user devices 101 (e.g., a desktop personal computer or a mobile device such as a mobile phone or a tablet) is described with respect to a product catalog platform 103. By way of example, a business may manage, modify, and/or deploy personalized products and/or services to one or more customer devices 105 (e.g., a desktop personal computer or a mobile device) via a data network 107 (e.g., the Internet) using the one or more business user devices 101. In one embodiment, the product catalog platform 103 may include or be associated with at least one commerce database 109, which may exist in whole or in part within the product catalog platform 103. In one embodiment, the at least one commerce database 109 may include customer profile data (e.g., location information and/or recent browsing history), products and/or services (e.g., identified by stock keeping units (SKUs)), prices, promotions, content (e.g., media items and/or relevant descriptive information), one or more rules (e.g., personalization rules, rules related to targeters, rules related to templates, rules related to tables, or a combination thereof).

As seen in FIG. 1, the data network 105 enables business user devices 101 and customer devices 105 and business users and customers, respectively, to access the features and functionality of the product catalog platform 103. In one embodiment, the data network 105 may be any local area network (LAN), metropolitan area network (MAN), wide area network (WAN), the Internet, or any other suitable packet-switched network, such as a commercially owned, proprietary packet-switched network, such as a proprietary cable or fiber-optic network.

In one embodiment, the system 100 provides an online product catalog framework to enables a business (e.g., Verizon) to manage and deploy up-to-date and personalized products and/or services to customers. More specifically, the product catalog framework includes a catalog management module, a pricing engine, a content management module, and a profile management module. In addition, in one embodiment, the product catalog framework is based on Oracle's ATG application platform. Further, in one embodiment, the online product catalog framework is based on at least two data centers, each including one or more commerce servers, at least one content management server, one or more database servers, or a combination thereof. Consequently, a small business customer or SMB, for example, can learn about a business' products and/or services, order them online, and/or track their delivery.

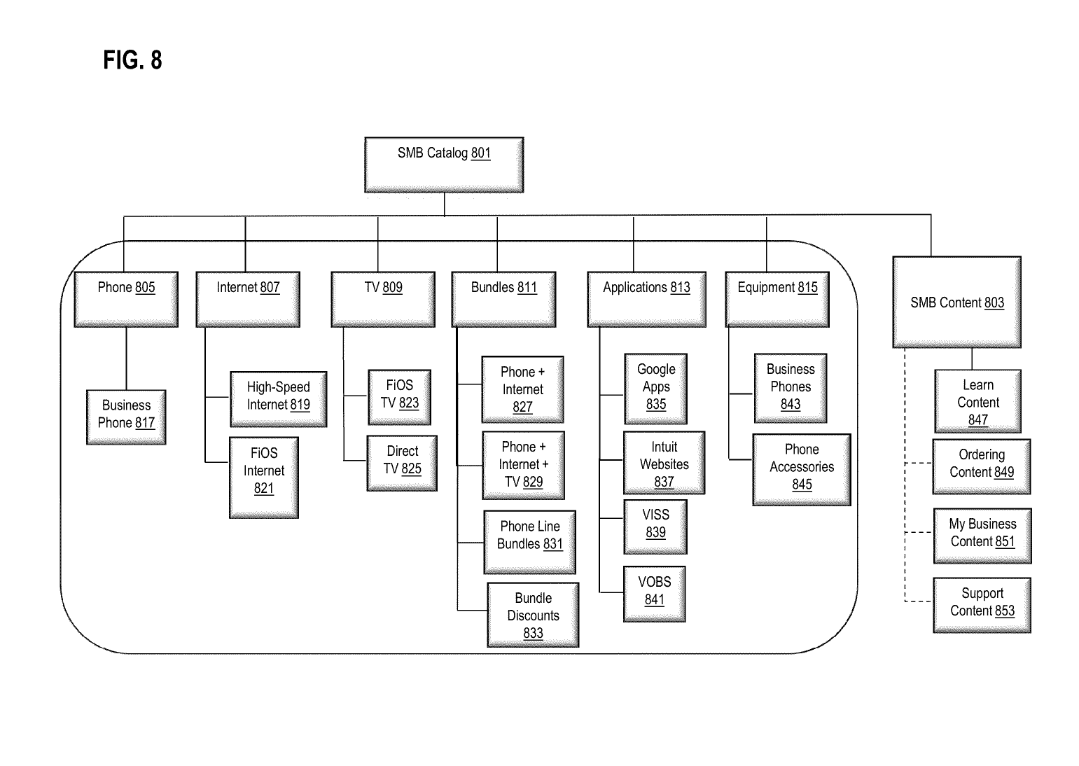

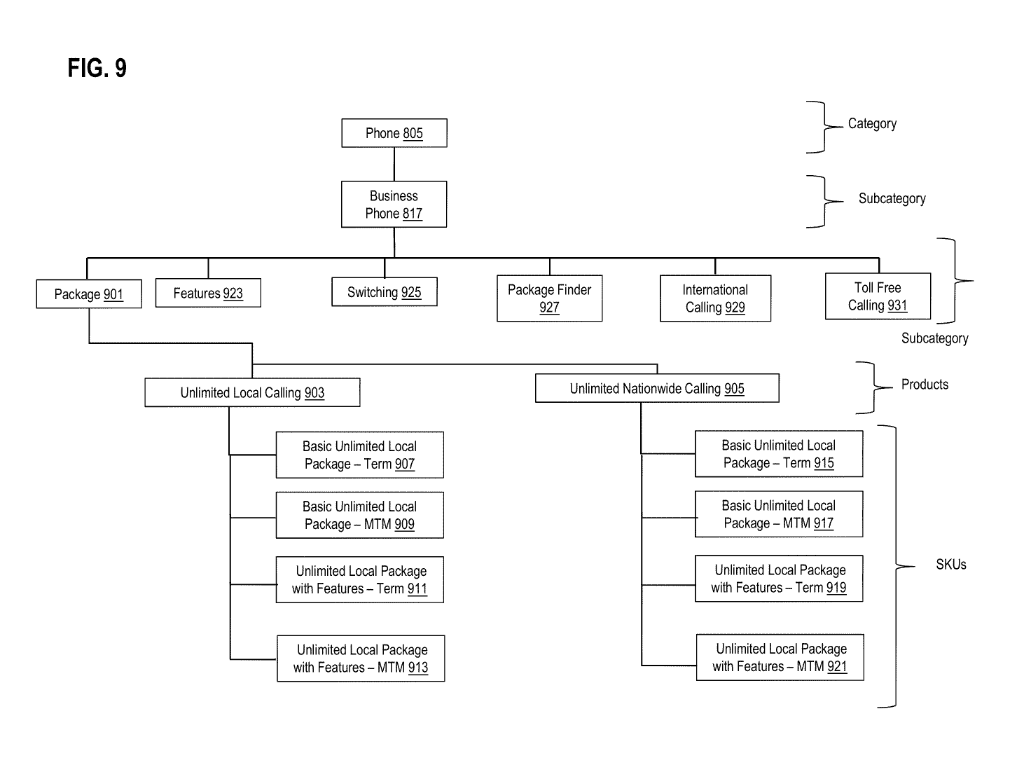

In one embodiment, the catalog management module of the system 100 enables a business user (e.g., an administrator) to organize the business' products and/or services into one or more categories for publication on an e-commerce website, for example. In one example use case, the one or more categories include phone, Internet, television, bundles, applications, and equipment. An illustrative example of a catalog hierarchy is depicted in FIG. 8. In one embodiment, the content can be further organized into learn-related content, ordering-related content, account and services-related content (e.g., My Business Content), and support-related content. In one embodiment, the catalog management module enables a business user to leverage the product catalog to handle any new products and to handle seamless migration of general business ordering (GBOrdering) and other domains into the ATG platform, for example. In one embodiment, each category (e.g., phone) can further be broken down into various subcategories, products, and SKUs as depicted in FIG. 9.

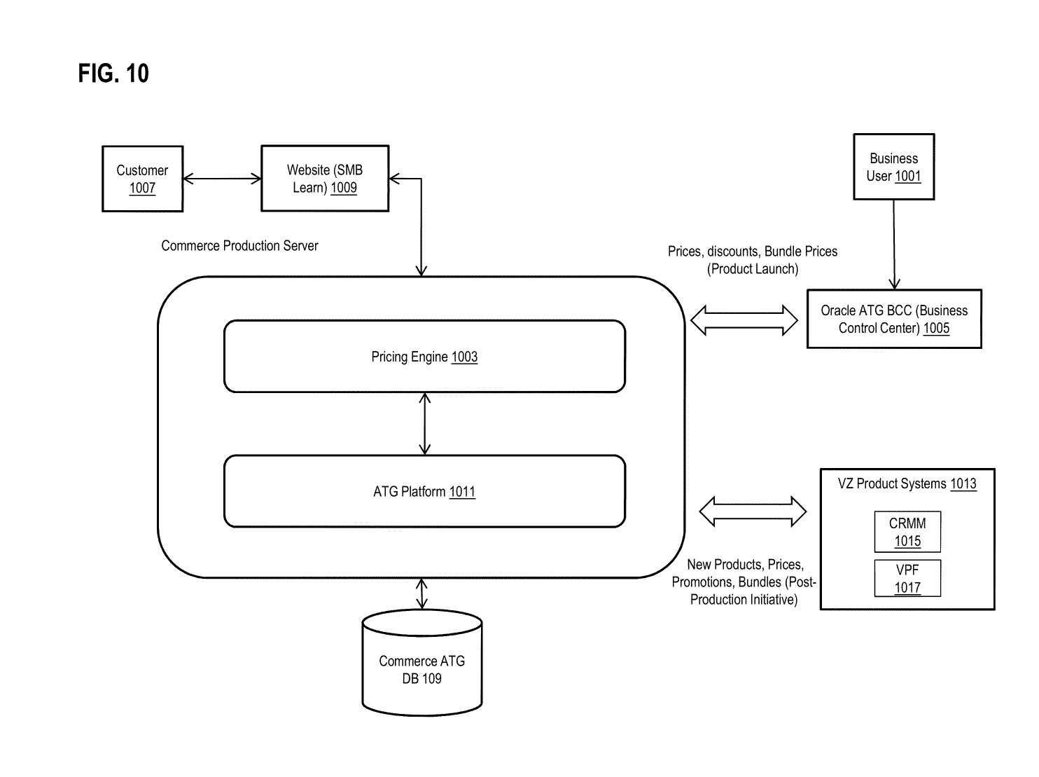

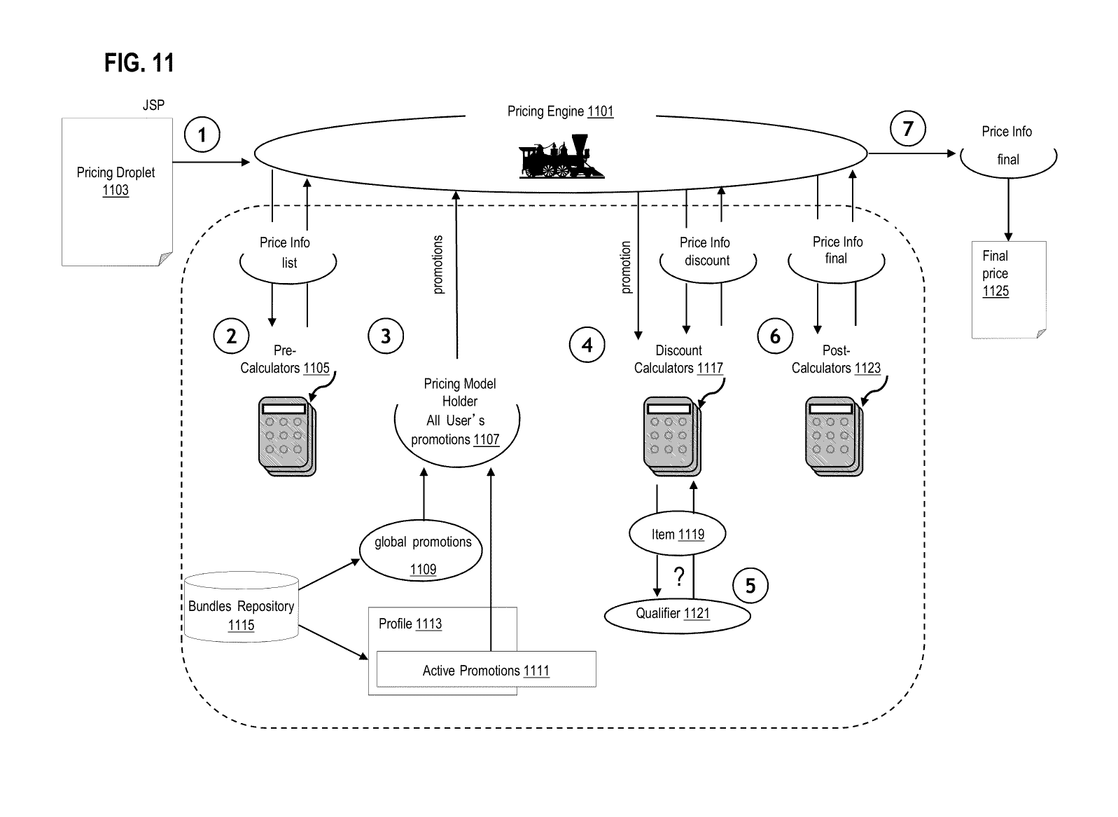

In one embodiment, the pricing engine of the system 100 is designed be a reusable and extendable rules-based and table-driven pricing infrastructure to support various products and/or services for ordering (e.g., GBOrdering), promotions, etc. on desktop and mobile devices (e.g., a mobile phone or a tablet). An illustrative example of the pricing engine is depicted in FIG. 10. More specifically, as illustrated in FIG. 11, the pricing engine determines price information from a JavaServer Pages (JSP) pricing droplet (step 1) and then iterates through a set of pre-calculators (step 2) to determine an initial price for a product or service. In one example use case, the pricing engine then applies any global or user-related promotions (step 3) and any applicable discounts (e.g., an item discount, an order discount, a shipping discount, etc.)(step 4). In one embodiment, the available discounts are dependent upon one or more applicable qualifiers (i.e., eligibility rules governing who can receive a particular price, discount, promotion, or benefit)(step 5). Thereafter, the pricing engine iterates through a set of post-calculators (step 6) to determine the final price of the product or service (step 7).

In one embodiment, the pricing schema is based on one or more tables designed to store product catalog information (e.g., dcs_price_list, dcs_price, dcs_sku, etc.). In one example use case, a SKU can also be mapped to multiple prices. For example, a telecom Basic Unlimited Local Package (Term) can be mapped by default to a nationwide price, a particular price for an area within one or more states, etc. Moreover, an SMB Pricelist table and an SMB Price table, for example, can contain the details from a “Master Pricing” sheet, for example, including various state codes, prices for month-to-month (MTM) services, term services, discounts, etc. In one embodiment, the SMB Price List table, for example, is scalable and additional filters such as a Common Language Identifier (CLLI) Code, a Log File Analyzer (LFA) command, etc. can be added to the pricing engine to come up with the final price to be displayed. Further, in one embodiment, the pricing engine may be used to build custom bundles of services to meet a customer's particular needs (e.g., Internet, phone, applications, and/or television).

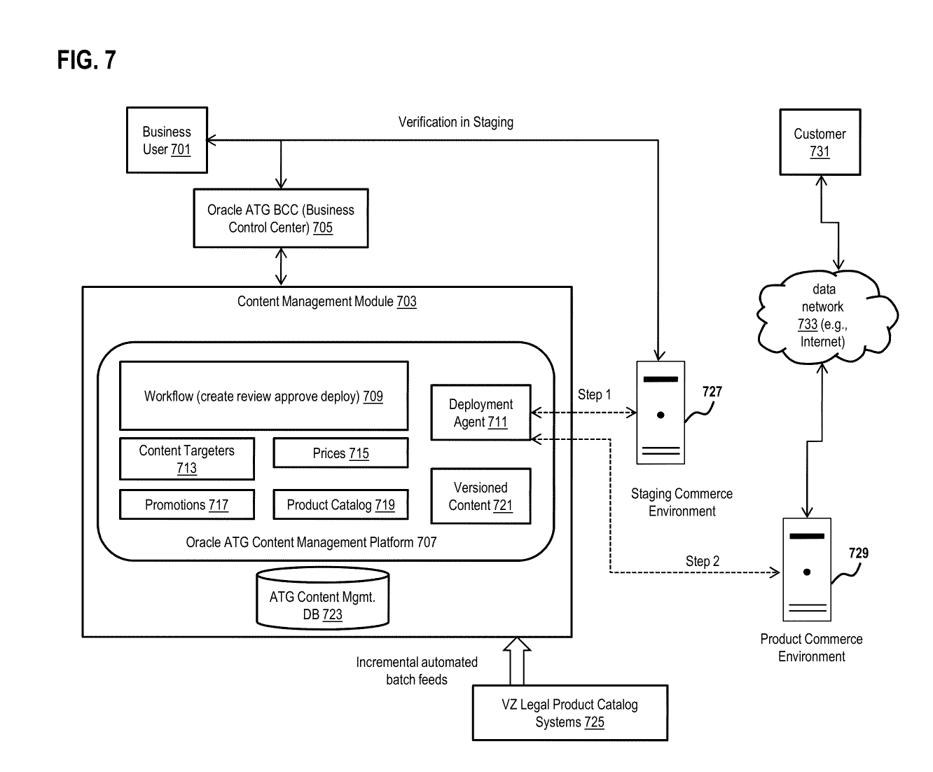

In one embodiment, the content management module of the system 100 enables a business user (e.g., an administrator) to deploy new products, promotions and/or services and to manage one or more workflows for creating, approving, and/or deploying content. An illustrative example of the content management module is depicted in FIG. 7. More specifically, the content management module enables the system 100 to maintain multiple versions of products and/or services and to enable the business user to target content, products, and/or promotions to specific regions and/or customers. In one embodiment, the content management module supports incremental batch feeds from a business' legacy product catalog systems (e.g., Verizon legacy product catalog systems) based on any order discount (PCR).

In one embodiment, the profile management module of the system 100 enables a business user (e.g., an administrator) to personalize the presentation of products and/or services to ensure that the right content is presented to the right people through the right channel at the right time. In one embodiment, the types of personalization can be explicit (e.g., profile-driven and/or based on content-targeting rules); implicit (e.g., behavior driven and/or based on scenarios, rules, etc.); multi-stage (e.g., based on events, time, lifecycles, scenarios, rules, etc.); and/or predictive (e.g., data-driven, real-time behavior driven, based on statistical data, automated analytics-driven, etc.). In one example use case, the profile management module enables personalization of the product catalog based on browsing history, profile attributes, or a combination thereof. In addition, the profile management module enables the system 100 to access commerce specific profile properties such as shipping and billing addresses, credit card information, etc. related to one or more customers. For example, a customer may have more than one shipping address associated with his or her account.

In one embodiment, the system 100 manages the catalog management module, the pricing engine, and the content management module separately. As a result, a business user (e.g., an administrator) has more flexibility to personalize an offering of products and/or services than if the various modules and engine were lumped together.

In one embodiment, the system 100 generates a personalized product catalog by using one or more rules-based targeters, one or more rules-based templates, or a combination thereof with the catalog management module, the pricing engine, the content management, the profile management module, or a combination thereof. In one embodiment, the one or more rules-based targeters, the one or more rules-based templates, or a combination thereof are based on (1) the profile information, the order information, or a combination thereof; (2) one or more inputs by one or more business users (e.g., an administrator); or (3) a combination thereof. For example, the rules-based targeters enable the system 100 to deliver dynamic and personalized content to various website visitors. More specifically, a targeter defines product items to display to site visitors who meet the targeter's criteria. In addition, the targeter may also specify the times and conditions under which the system 100 will present the content. In one example use case, a business user (e.g., an administrator) can modify one or more rules-based targeters with the Oracle ATG Business Control Center (BCC) tool. As previously discussed, the system 100 enables a business user to create multiple rules to target the content based on profile attributes like state, zip code, and/or recent browsing history. In addition, the system 100 also enables a business user to manage the one or more rules-based templates so that content and media items (e.g., images) can be easily rearranged (e.g., a banner adjustment). By way of example, in one version of a business website, media such as a stock photograph may be published on the left side of the site with content on the right, but in another version of the website, the media may be rearranged and published on the right side of the site with the content on the left side.

In one embodiment, the system 100 determines pricing data based on one or more customer sales zones (e.g., a particular state, zip code, etc.). By way of example, the pricing data includes prices, discounts, bundle prices, or a combination thereof based on pricing droplets, tables, or a combination thereof. More specifically, at the time of an initial production launch, a business user (e.g., an administrator) can use the graphical user interface (GUI) of the Oracle ATG BCC to upload pricing data based on the one or more customer sales zones. As a result, the system 100 can present personalized online content to various customers (i.e., content that changes dynamically for each site visitor).

In one embodiment, the system 100 causes at least one presentation of the personalized product catalog in at least one staging commerce environment associated with the content management module for verification by a business user. By way of example, a business user (e.g., an administrator) can input product catalog information to the content management module using the Oracle ATG BCC interface, which the business user can then verify in the staging commerce environment. In particular, the staging commerce environment enables a business user to update a product catalog and test such changes before propagating the change to the production commerce environment.

In one embodiment, the system 100 causes at least one deployment of the personalized product catalog in at least one production commerce environment associated with the content management module based on the verification by a business user, for example. In particular, once the system 100 causes the deployment of the personalized product catalog to the production commerce environment, a customer can view and interact with the product catalog via the Internet using one or more customer devices (e.g., a desktop personal computer or a mobile device).

In one embodiment, the system 100 determines the profile information, the order information, or a combination thereof based on one or more inputs by one or more customers. By way of example, the one or more inputs may include a customer entering his or her account information, a customer viewing a business' website (e.g., to view various bundle options), the geo-location of the customer (e.g., based on a state and/or a zip code), etc. In one or more embodiments, the system 100 determines the content information via the content management module based on one or more inputs by one or more business users (e.g., an administrator). More specifically, a business user can manage and deploy the content information via the content management module using the Oracle ATG BCC interface, for example.

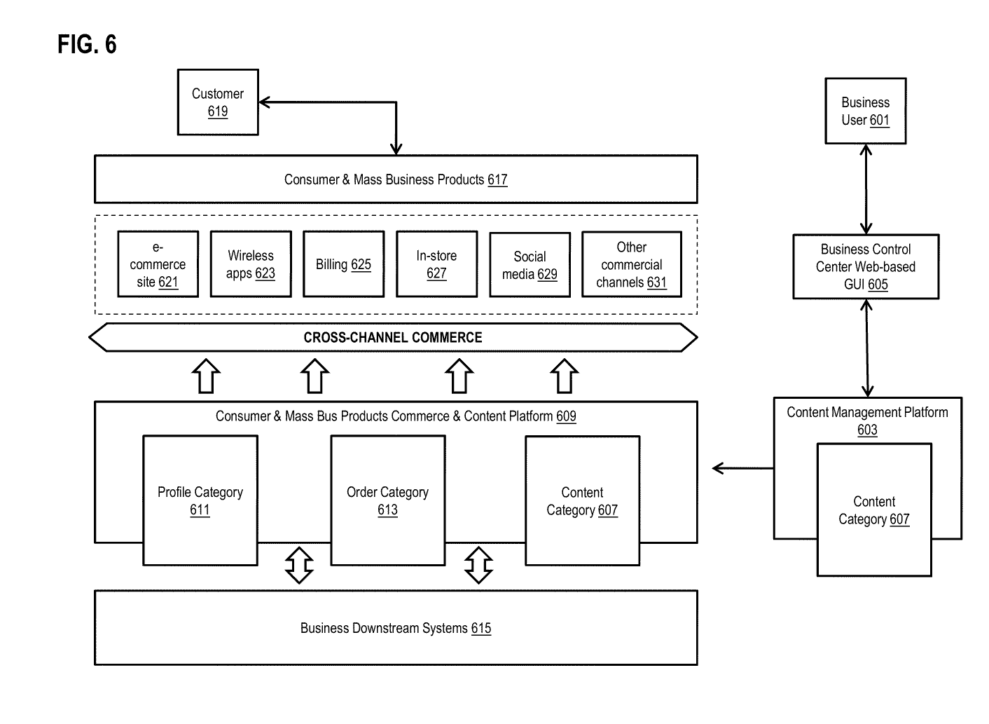

In one embodiment, the system 100 causes a presentation of the personalized product catalog on one or more device types (e.g., desktop personal computers or mobile devices) across one or more commerce channels (i.e., cross-channel commerce) based on profile information, order information, content information, or a combination thereof. An illustrative example of the cross-channel architecture of the system 100 is depicted in FIG. 6. By way of example, the cross-channel commerce may include an e-commerce website (e.g., Verizon.com), wireless applications (e.g., for different mobile operating systems), billing systems (e.g., CoFee AnyWhere), In-store (e.g., a Verizon retail store), social media, other commerce channels (e.g., FiOS TV Central). In addition, in one embodiment, the profile information includes account information, social network information, behavior information, browser history information, geo-location information, or a combination thereof related to a customer. In one embodiment, the order information includes information related to a specific order, order history information, shopping cart information, browser history information, geo-location information, or a combination thereof. Further, in one embodiment, the content information includes product information, promotions, messages, general information, prices, self-services, or a combination thereof.

In one embodiment, the system 100 determines one or more data feeds based on the one or more product catalog systems. More specifically, once the personalized product catalog is available to a customer on a business' website (i.e., Post-production), the pricing engine can consume automated data feeds from a product catalog system (e.g., Verizon Product Catalog Systems including Product Catalog and Qualification suite of applications). For example, the automated data may include new products, prices, promotions, bundles, etc.

In one embodiment, the system 100 determines at least one modification of the one or more rules, one or more tables, one or more templates, or a combination thereof associated with the online product catalog framework. More specifically, a business user (e.g., an administrator) can modify the one or more rules using the Oracle ATG BCC interface, for example. For example, in addition to targeting the content based on profile attributes like state, zip code, or browsing history as discussed, the business user can also modify the rules to include attributes like country, company name, title, etc. By way of further example, a business user can also update one or more tables (e.g., a SMB Price Table) to adjust one or more prices of the products and/or services being offered (e.g., a Basic Unlimited Local telephone calling package). Thereafter, in one embodiment, the system 100 causes at least one update of the personalized product catalog based on the at least one modification.

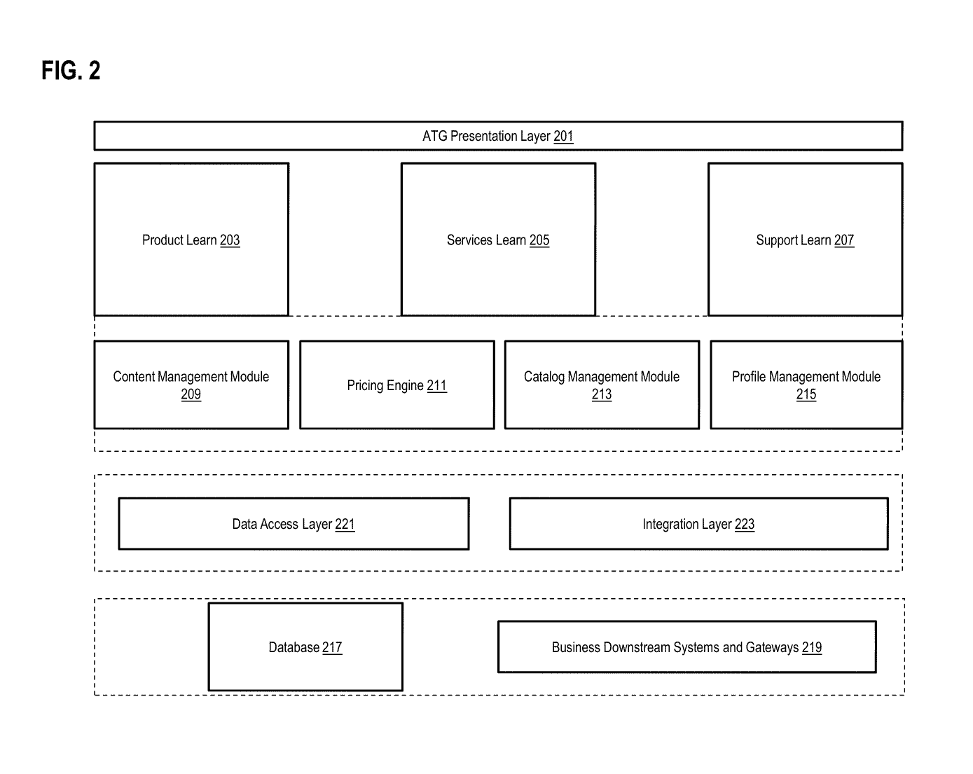

FIG. 2 is a diagram of the high-level architecture of the learn (discovery) and support content management functionalities of the system 100, according to one embodiment. In particular, the product learn category 203, the services learn category 205, and the support learn category 207 are categories of functionalities related to the content management module 209, the pricing engine 211, the catalog management module 213, and the profile management module 215, which are connected to the database 217 and business (e.g., Verizon) downstream systems and gateways 219 via the data access layer 221 and the integration layer 223. In one embodiment, the one or more functionalities are made available to customers via the ATG presentation layer 201. For example, in one embodiment, the product learn category 203 includes information related to user interface (UI) management, product catalog management, product search, personalization rules, and bundles (e.g., phone and internet services) & promotions information. Similarly, the services learn category 205 includes information related to managing services content, service recommendations, account management, and E-learning. Last, the support learn category 207 includes information related to maintaining frequently asked questions (FAQ) content, providing product documentation, order status, and repair support.

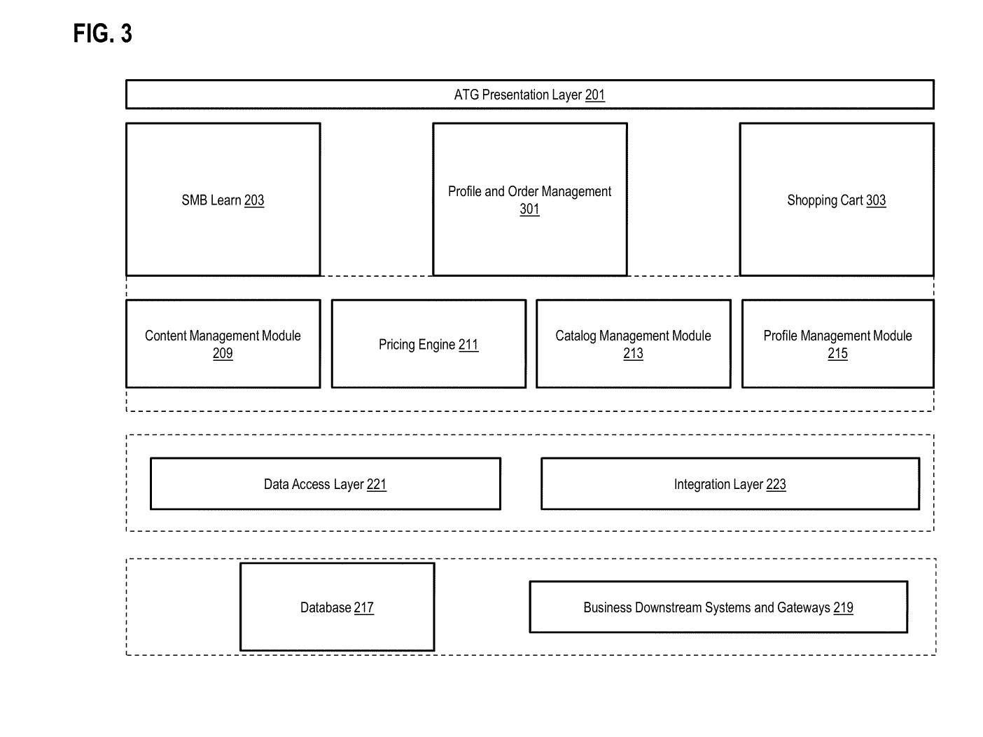

FIG. 3 is a diagram of the high-level architecture of the ordering functionality of the system 100, according to one embodiment. In particular, the high-level architecture of the ordering functionality of the system 100 is identical to the high-level architecture of the learn and support content management functionalities of the system 100, except that the architecture of the ordering functionality includes an order management category 301 and a shopping cart 303 category instead of the services learn category 205 and the support learn category 207, respectively. In one embodiment, the profile and order management category 301 includes information related to profile management, order tracking, cross-channel session management and tracking, and learn and ordering integration for seamless navigation. Likewise, the shopping cart category 303 includes information related to cart management, cart abandonment tracking, and personalized cross-sell and up-sell.

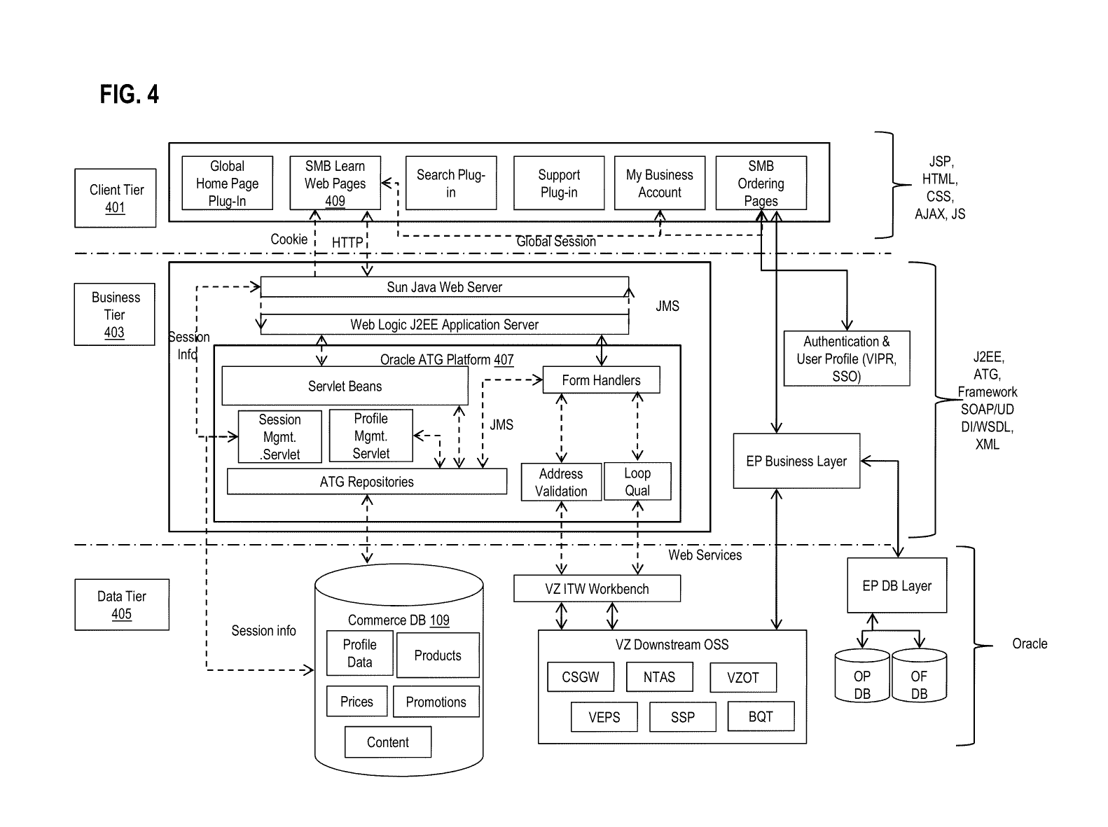

FIG. 4 is a diagram of the commerce software architecture of the system 100 that be used to implement an embodiment of the invention. In one embodiment, the architecture is generally separated into a client tier 401, a business tier 403, and a data tier 405. In one embodiment, the software architecture of the system 100 is based on the Oracle ATG platform 407, which enables a business user (e.g., an administrator) to manage and deploy content to one or more customers via a SMB learn web page 409, for example, without dependency on IT personnel or IT releases. More specifically, the dashed lines represent new code/interface and the solid lines represent BAU code/interface. In addition, components within the business tier 403 use Java Message Service (JMS) as a mode of communication.

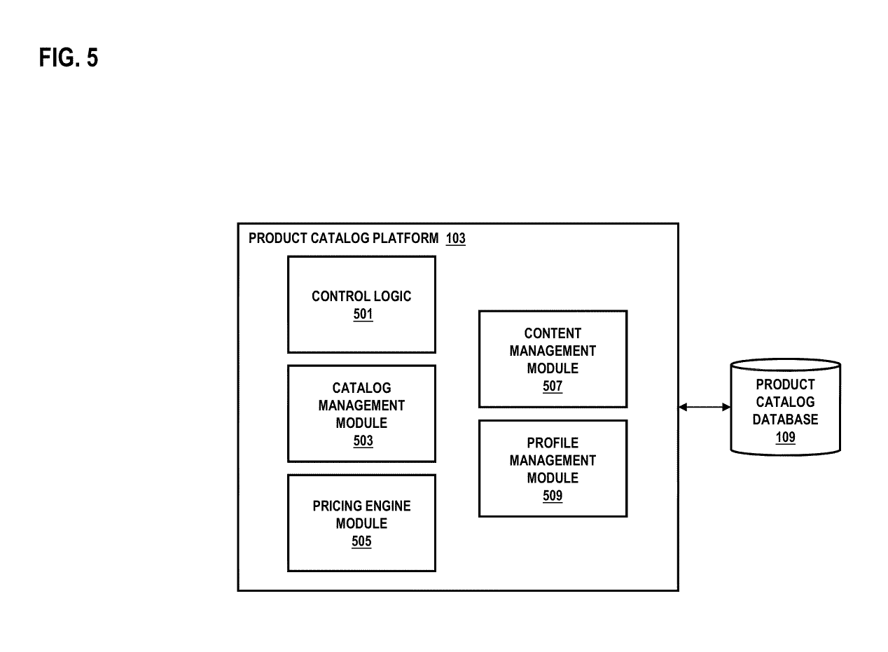

FIG. 5 is a diagram of the components of the product catalog platform 103, according to one embodiment. By way of example, the product catalog platform 103 includes one or more components for providing an online product catalog framework that enables a business to manage and deploy up-to-date and personalized products and/or services to customers using cross-channel commerce without dependency on IT specialists or IT releases. It is contemplated that the functions of these components may be combined in one or more components or performed by other components of equivalent functionality. In this embodiment, the product catalog platform 103 includes a control logic 501, a catalog management module 503, a pricing engine module 505, a content management module 507, and a profile management module 509.

In one embodiment, the control logic 501 oversees tasks, including tasks performed by the catalog management module 503, the pricing engine module 505, the content management module 507, and the profile management module 509. For example, although the other modules may perform the actual task, the control logic 501 may determine when and how those tasks are performed or otherwise direct the other modules to perform the task. In one embodiment, the control logic 501 is used to manage the catalog management module 503, the pricing engine module 505, and the content management module 507 separately.

In one embodiment, the catalog management module 503 is used to generate a personalized product catalog by using one or more rules-based targeters, one or more rules-based templates, or a combination thereof with the pricing engine module 505, the content management module 507, the profile management module 509, or a combination thereof. In one embodiment, the catalog management module 503 may also be used to cause a presentation of the personalized product catalog on one or more devices types across one or more commerce channels based on profile information, order information, content information, or a combination thereof. The catalog management module 503 also may be used to determine at least one modification of the one or more rules, one or more tables, or a combination thereof associated with the online product catalog framework. Further, in one embodiment, the catalog management module 503 may also be used to cause at least one update of the personalized product catalog based on the at least one modification of the one or more rules, the one or more tables, or a combination thereof.

In on embodiment, the pricing engine module 505 is used to determine pricing data (e.g., one or more prices, one or more discounts, one or more bundles, or a combination thereof) based on one or more customer sales zones (e.g., a particular state, zip code, etc.). The pricing engine module 505 may also be used to determine one or more data feeds based on the one or more product catalog systems (e.g., Verizon product systems).

In one embodiment, the content management module 507 is used to cause at least one presentation of the personalized product catalog in at least one staging commerce environment for verification by one or more business users (e.g., an administrator). The content management module 507 may also be used to cause at least one deployment of the personalized product catalog in at least one production commerce environment based on the verification. The content management module 507 also may be used to determine content information based on one or more inputs from one or more business users (e.g., a business user using the Oracle ATG BCC interface).

In one embodiment, the profile management module 509 is used to determine profile information (e.g. account information), order information (e.g., order history), or a combination thereof based on one or more inputs by one or more customers (e.g., a customer's recent browsing history).

FIG. 6 is a diagram of the system 100 cross-channel architecture that can be used to implement an embodiment of the invention. As illustrated, in one embodiment, a business user 601 can manage and deploy products and/or services to the content management platform 603 via the Oracle ATG BCC web-based GUI 605. As previously discussed, in one example use case, the content category 607 includes products, promotions, messages, information, prices, and support. The information provided by the business user 601 is then provided to the consumer and mass business products commerce and content platform 609, which includes the profile category 611, the order category 613, and the content category 607. In one example use case, the profile category 611 includes account information, social networks, behavior, browser history, and geo-location information and the order category 613 includes order information, order history, shopping cart information, browser history, and geo-location information. In one embodiment, the consumer and mass business products commerce and content platform 609 is also able to retrieve data from business downstream systems 615 (e.g., Verizon Downstream Systems). The resulting consumer and mass business products 617 are then made available to a customer 619 using one or more devices (e.g., a desktop personal computer or a mobile device) by the consumer and mass business products commerce and content platform 609 using cross-channel commerce such as an e-commerce website 621 (e.g., Verizon.com), wireless applications 623 (e.g., Verizon wireless applications for different mobile operating systems), billing services 625 (e.g., Verizon's CoFee Anywhere), In-store 627 (e.g., a Verizon retail store), social media (e.g. Facebook, Twitter, etc.) 629, and other commercial channels 631 (e.g., FiOS TV Central).

FIG. 7 is a diagram of the content management module illustrating how the system 100 manages content such as products and/or services, according to one embodiment. Similar to FIG. 6, a business user 701 can manage and deploy products and/or services to the content management module 703 via the Oracle ATG BCC web-based GUI 705. In one embodiment, the content management 703 includes the Oracle ATG Content Management Platform 707 that includes a workflow component 709, a deployment agent 711, content targeters 713, prices 715, promotions 717, product catalog 719, and versioned content 721 and the content management module 703 also has access to an ATG content management database 723. In addition, the content management module 703 can receive incremental automated batch feeds from a business (e.g., Verizon) legacy product catalog systems 725. Thereafter, in step 1, the deployment agent 711 deploys the personalized product catalog to a staging commerce environment 727 for verification by the one or more business users 701 (e.g., an administrator). Once the personalized product catalog is verified, the deployment agent 711 deploys the personalized product catalog to a production commerce environment 729, where a customer 731 can view and/or order the products and/or services via a data network 733 (e.g., the Internet).

FIG. 8 is a diagram of the hierarchy of a product catalog 801 (e.g., an SMB catalog), according to one embodiment. In this example use case, the product catalog management and content management are separated as shown by the product catalog 801 and the SMB content 803 nodes. In one embodiment, the product catalog 801 includes one or more categories including phone 805, Internet 807, Television 809, Bundles 811, Applications 813, and Equipment 815. Each catalog category may also include one or more products and/or services (e.g., business phone 817, phone line bundles 831, phone accessories 845, etc.). An illustrative example of a hierarchy of the product catalog categories (e.g., phone 805) is depicted in FIG. 9. In one embodiment, the SMB content 803, for example, is also broken down into categories including learning content 847, ordering content 849, account and services content 851 (e.g., My Business Content), and support content 853. In addition, the product catalog design can be leveraged to handle any new products related to the various product categories 805-815 and/or content categories 847-853.

FIG. 9 is a diagram of the hierarchy of a product catalog category, according to one embodiment. In one embodiment, the hierarchy of the product catalog category (e.g., phone 805) includes at least a first and a second set of subcategories and one or more products associated with the second subcategory identified by SKUs that be used by the pricing engine to determine pricing information for the one or more products. For example, as illustrated, Business Phone 817 is a subcategory of the phone category 805 and package 901 is a subcategory of Business Phone 817. More specifically, the package 901 subcategory includes unlimited local calling 903 and unlimited nationwide calling 905 products and/or services, each with specific products and/or services identified by different SKUs (e.g., Basic Unlimited Local Package—Term 907, Basic Unlimited Local Package—MTM 909, etc.).

FIG. 10 is a diagram of the high-level architecture of the pricing engine, according to one embodiment. Similar to FIGS. 6 and 7, one or more business users 1001 (e.g., an administrator) can upload and/or modify pricing data (e.g., prices, discounts, bundle prices, etc.) at the time of a production launch to the pricing engine 1003 by using the Oracle ATG BCC interface 1005, for example. In particular, the one or more business users can use the GUI screen of the Oracle ATG BCC 1005 to upload pricing data based on sales zones (e.g., a particular state, zip code, etc.). Once the product is launched, a customer 1007 can view and learn about one or more products via one or more pages on a company's website 1009 (e.g., an SMB learn page). In one embodiment, the pricing engine 1003, in connection with the ATG Platform 1011, can also consume automated data feeds from the business product system 1013 (e.g., Verizon product systems), which includes one or more product catalog and qualification applications (e.g., the centralized qualification layer for bundles, promotions, products, etc. 1015 (CRMM) and the Verizon Product Catalog Hosting application 1017 (VPF)). In addition, the pricing engine 1003 and the ATG Platform 1011 also interact with the Commerce ATG DB 109.

FIG. 11 is a diagram of the pricing engine module, according to one embodiment. As previously discussed, in step 1, the pricing engine 1101 determines price information from a JSP pricing droplet 1103 and then iterates through a set of pre-calculators 1105 (step 2) to determine an initial price for a product or service (e.g., Basic Unlimited Local Package—Term). In one embodiment, in step 3, the pricing engine 1101 then applies all user-related promotions 1107, based on one or more global promotions 1109 and/or one or more active promotions 1111 based on a user's profile 1113. In particular, both sets of promotions (1109 and 1111) are determined from the bundles repository 1115. In step 4, the pricing engine 1101 applies any applicable discounts (e.g., an item discount, an order discount, a shipping discount, etc.) using one or more discount calculators 1117. In one embodiment, the one or more available discounts are dependent upon the one or more items 1119 and one or more applicable qualifiers 1121 (i.e., eligibility rules governing who can receive a particular price, discount, promotion, or benefit) as illustrated in step 5. Thereafter, in step 6, the pricing engine 1101 iterates through a set of post-calculators 1123 to determine the final price 1125 of the product or service (step 7).

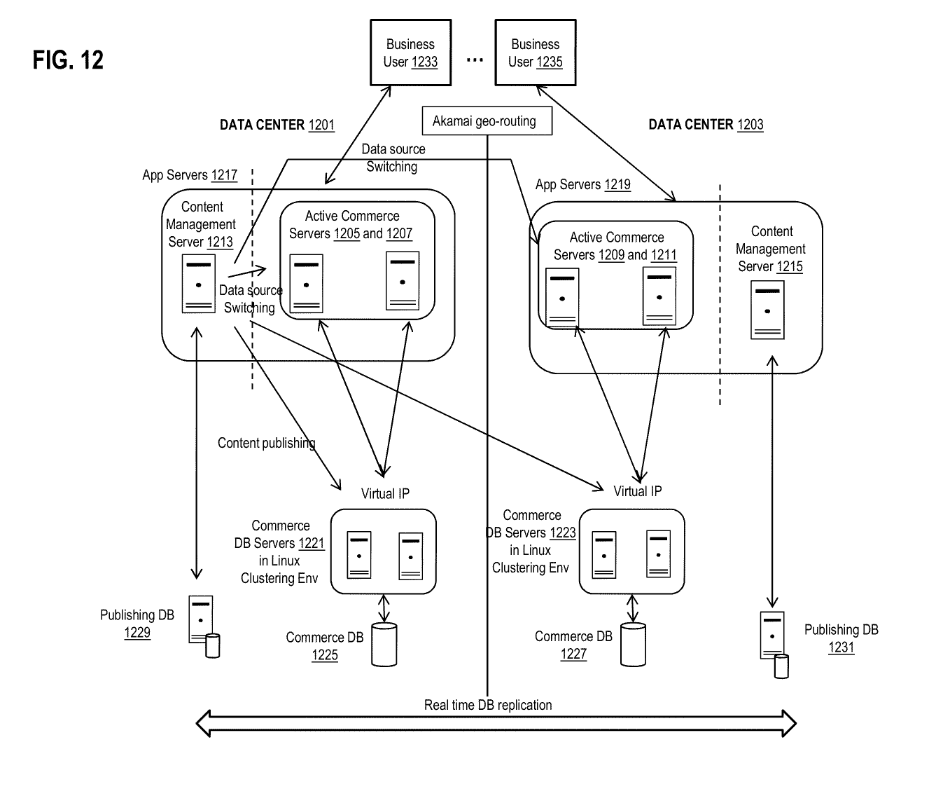

FIG. 12 is a diagram of the high-level system hardware layout, according to one embodiment. In particular, FIG. 12 illustrates how redundancy is maintained throughout the system 100. For example, the productive environment of FIG. 12 includes two data centers 1201 and 1203 (e.g., data center 1201 located in Sacramento, Calif. and data center 1203 located in Fairland, Md.). More specifically, both data centers 1201 and 1203 are in active/active mode using Akamai Geo-routing, for example. In addition, both commerce servers 1205 and 1207 in data center 1201 are active/active using NetScaler Load Balancer, for example, and both commerce servers 1209 and 1211 in data center 1203 are active/active using Netscaler Load Balancer, for example. The content management server 1213 (BCC) is active at data center 1201 and the content management server 1215 is passive at data center 1203. In one embodiment, the databases at data center 1201 can be used by app servers 1217 and databases at data center 1203 can be used by app servers 1219. Moreover, the database servers 1221 and 1223 in data centers 1201 and 1203, respectively, can use a Linux clustering environment to make them highly-available. In one embodiment, the content management server 1213 can publish any content changes to commerce database 1225 in data center 1201 and the commerce database 1227 in data center 1203. Further, the content management server 1213 can communicate with the commerce servers 1221 and 1223 in the data centers 1201 and 1203, respectively, to switch the commerce catalog data sources. In one embodiment, the content management database 1229 in data center 1201 gets replicated by the system 100 with the content management database 1231 in data center 1203.

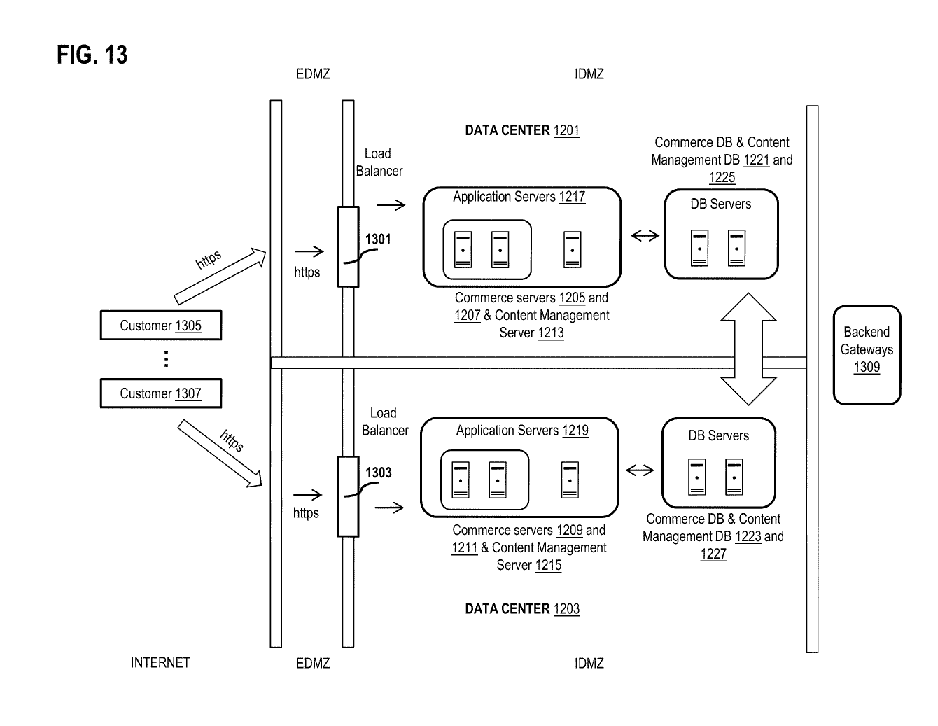

FIG. 13 is a diagram of the system hardware layout that can be used to implement an embodiment of the invention. In one embodiment, the system hardware architecture of FIG. 13 is based on Akamai infrastructure. Similar to FIG. 12, FIG. 13 also includes the two data centers 1201 and 1203 (e.g., in Sacramento and Fairland, respectively). More specifically, the data centers 1201 and 1203 can be active-active using Akamai Geo-routing, for example, and each data center can include the two active commerce servers 1205 and 1207 and 1209 and 1211, respectively, as well as one active/passive content management server 1213 and 1215, respectively. In one embodiment, Akamai can handle any fail over from one data center to another and also will load balance centers using Netscaler Load Balancers 1301 and 1303, for example. In one embodiment, it is contemplated that Akamai will be used for content caching and the hardware architecture of FIG. 13 can be scalable to handle SMB Ordering, Consumer-Learn/Ordering, etc.

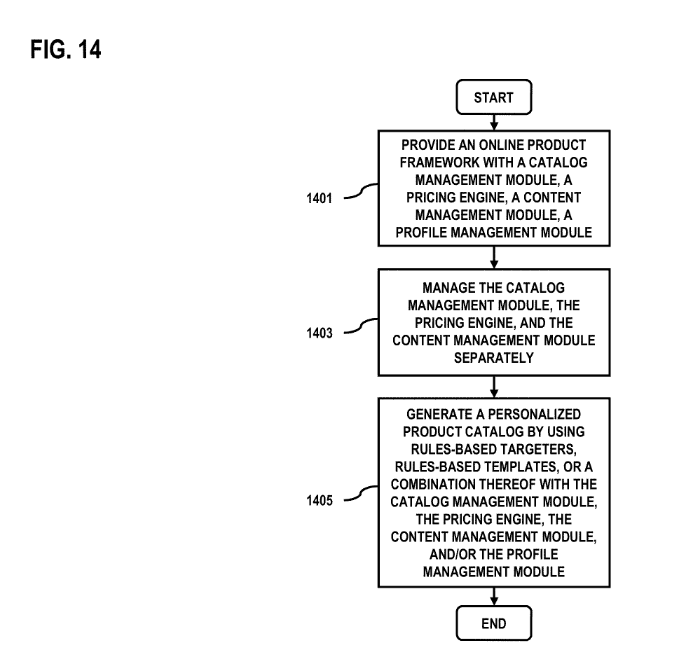

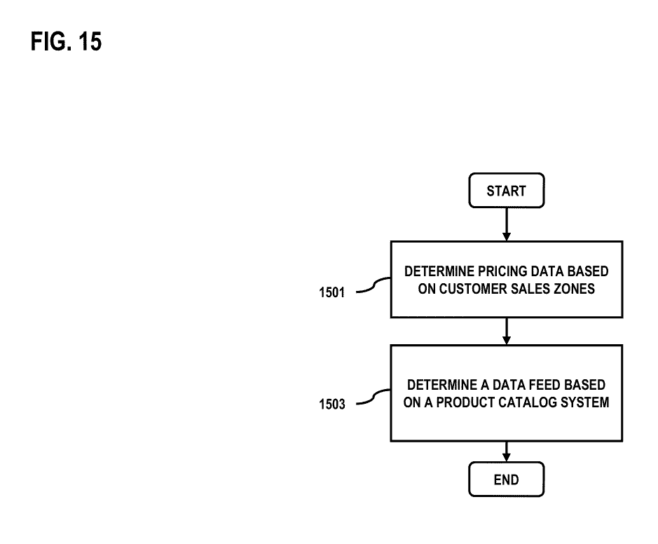

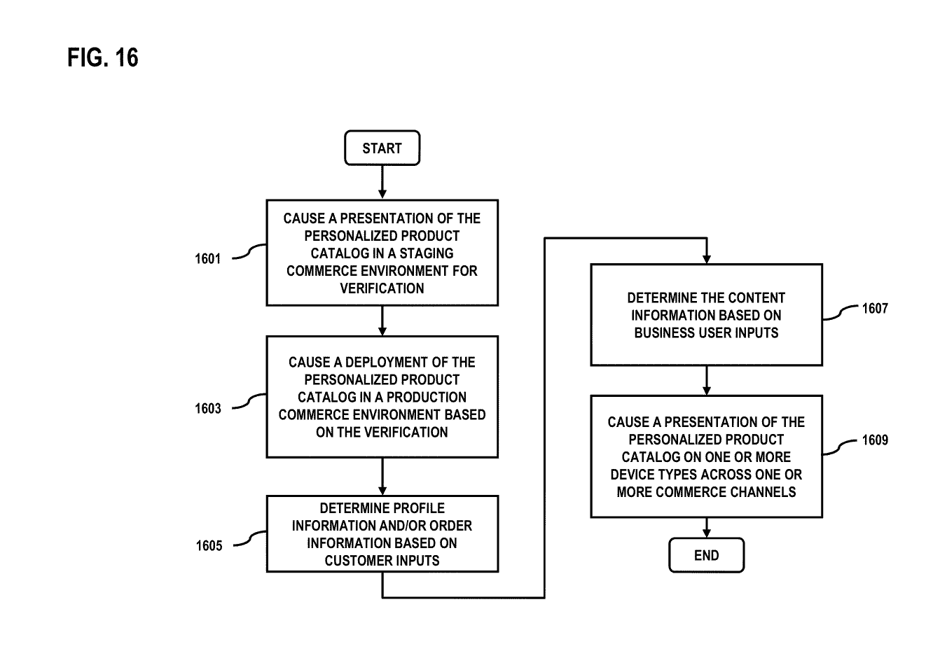

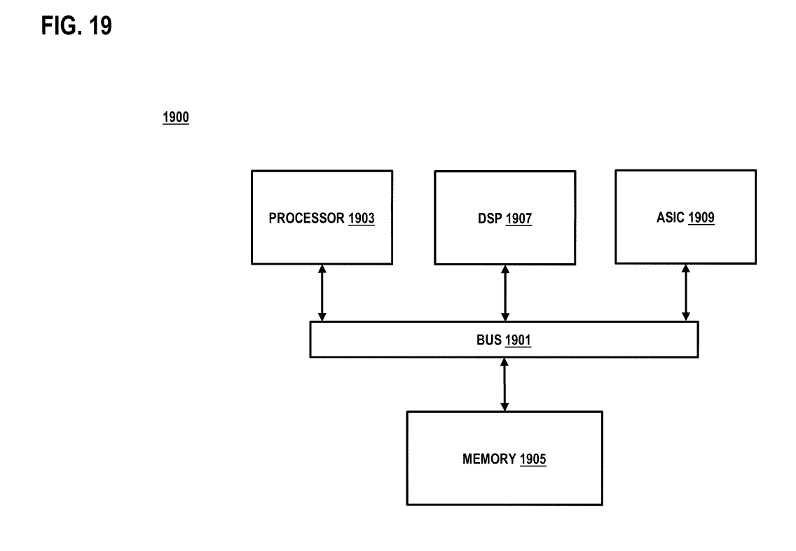

FIGS. 14-17 are flowcharts of processes for providing an online product catalog framework that enables a business to manage and deploy up-to-date and personalized products and/or services to customers using cross-channel commerce without dependency on IT specialists or IT releases, according to one embodiment. In one embodiment, the product catalog framework 103 performs the process 1400 and is implemented in, for instance, a chip set including a processor and a memory as shown in FIG. 19. In step 1401, the product catalog platform 103 provides an online product catalog framework, wherein the online product catalog framework includes a catalog management module, a pricing engine, a content management module, and a profile management module. By way of example, the online product catalog framework is based on Oracle's ATG framework application platform and the online product catalog framework enables one or more business users (e.g., an administrator) to manage and deploy up-to-date and personalized products and/or services to customers. More specifically, the online product catalog framework includes at least two data centers, each including one or more commerce servers, at least one content management server, one or more database servers, or a combination thereof.

By way of example, the catalog management module enables a business user to organize the business' products and/or services using Oracle's ATG BCC, for example, into one or more categories for publication on an e-commerce website, for example. Moreover, the pricing engine is designed to be a reusable and extendable rules-based and table-driven pricing infrastructure to support various products and/or services for ordering (e.g., GBOrdering), promotions, etc., on a desktop personal computer and/or one or more mobile devices (e.g., a mobile phone or a tablet). In addition, the content management module enables a business user using Oracle's ATG BCC, for example, to deploy new products, promotions, and/or services and to manage one or more workflows for creating, approving, and/or deploying content. Further, the profile management module enables a business user to personalize the presentation of the products and/or services to ensure that the right content is presented to the right people through the right channel at the right time. Consequently, once the personalized product catalog is made available by the product catalog platform 103, a small business customer, for example, can learn about a business' products and/or services, order them online, and/or track their delivery.

In step 1403, the product catalog platform 103 manages the catalog management module, the pricing engine, and the content management module separately. By of way of example, managing the various modules separately provides a business with a greater degree of flexibility to personalize the presentation and offering of products and/or services to customers compared to the various modules and engine being lumped together.

In step 1405, the product catalog platform 103 generates a personalized product catalog by using one or more rules-based targeters, one or more rules-based templates, or a combination thereof with the catalog management module, the pricing engine, the content management module, the profile management module, or a combination thereof. By way of example, the one or more rules-based targeters, the one or more rules-based templates, or a combination thereof are based on (1) customer profile information, ordering information, or a combination thereof; (2) one or more inputs by one or more business users (e.g., an administrator); or (3) a combination thereof. For example, the rules-based targeters enable the product catalog platform 103 to deliver dynamic and personalized content to various website visitors. More specifically, a targeter defines product items to display to site visitors who meet the targeter's criteria. Further, the one or more rules-based templates enable a business user to efficiently upload and arrange content and media items (e.g., images) related to the various products and/or services (e.g., banners).

FIG. 1500 depicts a process 1500 of how the rules-based and table-driven pricing engine is implemented. In one embodiment, the product catalog platform 103 performs the process 1500 and is implemented in, for instance, a chip set including a processor and a memory as shown in FIG. 19. In step 1501, the product catalog platform 103 determines pricing data based on one or more customer sales zones. By way of example, the pricing data includes prices, discounts, bundle prices, or a combination thereof based on pricing droplets, tables, or a combination thereof. More specifically, a business user (e.g., an administrator) can use the Oracle ATG BCC interface to upload pricing data based on the one or more customer sales zones. By way of further example, the one or more customer sales zones are based on geo-location information associated with a customer (e.g., a particular state, zip code, etc.).

In step 1503, the product catalog platform 103 determines one or more data feeds based on the one or more product catalog systems. By way of example, once the personalized product catalog is available to a customer on a business website (i.e., post-production), for example, the pricing engine of the product catalog platform 103 can consume automated data feeds from a product catalog system (e.g., Verizon's Product Catalog systems including one or more Product Catalog and Qualification applications). In one example use case, the automated data may include new products, prices, promotions, bundles, etc.

FIG. 1600 depicts a process 1600 of how the personalized product catalog is generated and presented to a customer. In one embodiment, the product catalog platform 103 performs the process 1600 and is implemented in, for instance, a chip set including a processor and a memory as shown in FIG. 19. In step 1601, the product catalog platform 103 causes at least one presentation of the personalized product catalog in at least one staging commerce environment associated with the content management module for verification by the one or more business users. By way of example, a business user (e.g., an administrator) can input product catalog information to the content management module of the product catalog platform 103 using the Oracle ATG BCC interface, which the business user can then verify in the staging commerce environment as opposed to a production environment. More specifically, the staging commerce environment enables a business user to update a product catalog and test such changes before propagating the change to the production commerce environment.

In step 1603, the product catalog platform 103 causes at least one deployment of the personalized product catalog in at least one production commerce environment associated with the content management module based on the verification, wherein the personalized product catalog is further based on one or more incremental batch feeds from one or more product catalog systems. In one example use case, once the product catalog platform 103 causes the deployment, a customer can view and interact with the product catalog via the Internet using one or more devices (e.g., a desktop personal computer or a mobile device such as a mobile phone or a tablet). By way of example, a product catalog system may include Verizon's Legal Product Catalog systems. In addition, the one or more incremental batch feeds may be based on any order discount (PCR).

In step 1605, the product catalog platform 103 determines the profile information, the order information, or a combination thereof based on one or more inputs by one or more customers. For example, the one or more inputs may include a customer entering his or her account information, a customer viewing a business' website (e.g., to view various bundle options), the geo-location of a customer (e.g., based on a particular state and/or zip code), etc.

In step 1607, the product catalog platform 103 determines the content information via the content management module based on one or more inputs by one or more business users. By way of example, a business user (e.g., an administrator) can manage and deploy the content information via the content management module of the product catalog platform 103 using the Oracle ATG BCC interface.

In step 1609, the product catalog platform 103 causes a presentation of the personalized product catalog on one or more device types across one or more commerce channels based on profile information, order information, content information, or a combination thereof. By way of example, the cross-channel commerce may include an e-commerce website (e.g., Verizon.com), wireless applications (e.g., for different mobile operating systems), billing systems (e.g., CoFee AnyWhere), In-store (e.g., a Verizon retail store), social media (e.g., Facebook, Twitter, etc.), other commerce channels (e.g., FiOS TV Central). Moreover, in one example use case, the profile information includes account information, social network information, behavior information, browser history information, geo-location information, or a combination thereof related to a customer. In one embodiment, the order information includes information related to a specific order, order history information, shopping cart information, browser history information, geo-location information, or a combination thereof. Further, in one example use case, the content information includes product information, promotions, messages, general information, prices, self-services, or a combination thereof.

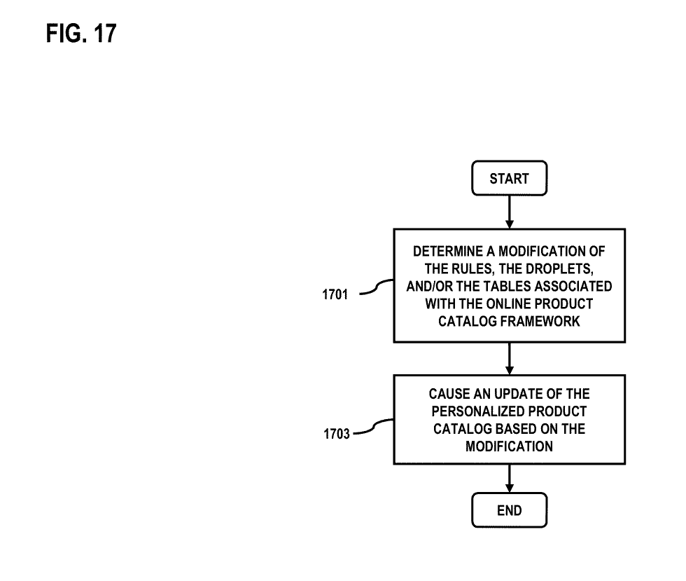

FIG. 17 depicts a process 1700 of modifying and/or updating one or more personalized product catalogs. In one embodiment, the product catalog platform 103 performs the process 1700 and is implemented in, for instance, a chip set including a processor and a memory as shown in FIG. 19. In step 1701, the product catalog platform 103 determines at least one modification of the one or more rules, one or more tables, one or more templates, or a combination thereof associated with the online product catalog framework. By way of example, a business user (e.g., an administrator) can modify the one or more rules using the Oracle ATG BCC interface. In addition, a business user can also update one or more tables (e.g., an SMB Price Table) to adjust one or more prices of the one or more products and/or services being offered. Consequently, in step 1703, the product catalog platform 103 causes at least one update of the personalized product catalog based on the at least one modification, wherein the presentation of the personalized product catalog is further based on the at least one update.

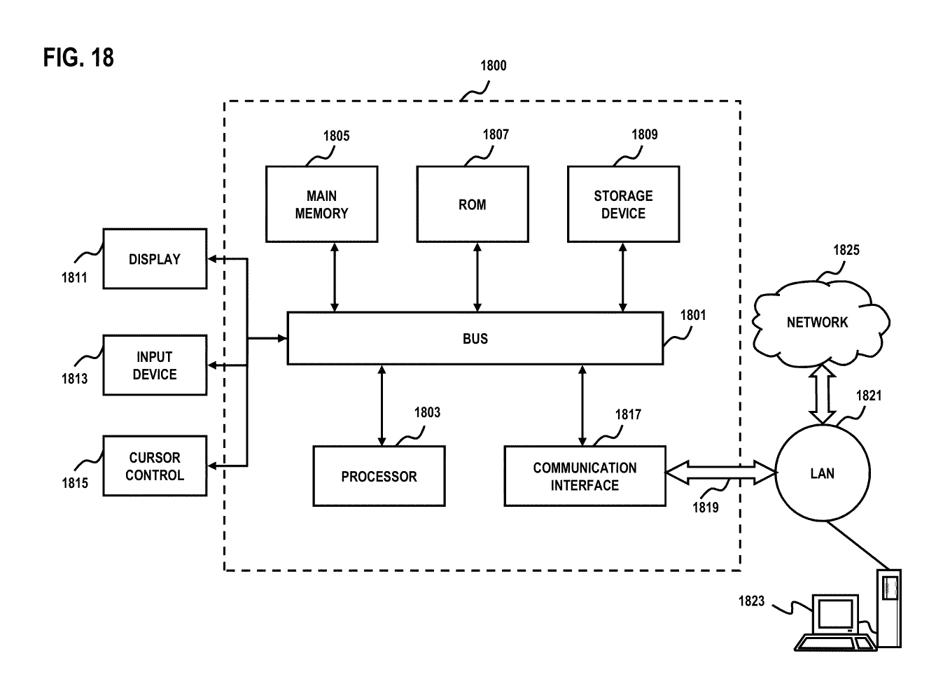

FIG. 18 illustrates computing hardware (e.g., computer system) upon which an embodiment according to the invention can be implemented. The computer system 1800 includes a bus 1801 or other communication mechanism for communicating information and a processor 1803 coupled to the bus 1801 for processing information. The computer system 1800 also includes main memory 1805, such as random access memory (RAM) or other dynamic storage device, coupled to the bus 1801 for storing information and instructions to be executed by the processor 1803. Main memory 1805 also can be used for storing temporary variables or other intermediate information during execution of instructions by the processor 1803. The computer system 1800 may further include a read only memory (ROM) 1807 or other static storage device coupled to the bus 1801 for storing static information and instructions for the processor 1803. A storage device 1809, such as a magnetic disk or optical disk, is coupled to the bus 1801 for persistently storing information and instructions.

The computer system 1800 may be coupled via the bus 1801 to a display 1811, such as a cathode ray tube (CRT), liquid crystal display, active matrix display, or plasma display, for displaying information to a computer user. An input device 1813, such as a keyboard including alphanumeric and other keys, is coupled to the bus 1801 for communicating information and command selections to the processor 1803. Another type of user input device is a cursor control 1815, such as a mouse, a trackball, or cursor direction keys, for communicating direction information and command selections to the processor 1803 and for controlling cursor movement on the display 1811.

According to an embodiment of the invention, the processes described herein are performed by the computer system 1800, in response to the processor 1803 executing an arrangement of instructions contained in main memory 1805. Such instructions can be read into main memory 1805 from another computer-readable medium, such as the storage device 1809. Execution of the arrangement of instructions contained in main memory 1805 causes the processor 1803 to perform the process steps described herein. One or more processors in a multi-processing arrangement may also be employed to execute the instructions contained in main memory 1805. In alternative embodiments, hard-wired circuitry may be used in place of or in combination with software instructions to implement the embodiment of the invention. Thus, embodiments of the invention are not limited to any specific combination of hardware circuitry and software.

The computer system 1800 also includes a communication interface 1817 coupled to bus 1801. The communication interface 1817 provides a two-way data communication coupling to a network link 1819 connected to a local network 1821. For example, the communication interface 1817 may be a digital subscriber line (DSL) card or modem, an integrated services digital network (ISDN) card, a cable modem, a telephone modem, or any other communication interface to provide a data communication connection to a corresponding type of communication line. As another example, communication interface 1817 may be a local area network (LAN) card (e.g. for Ethernet™ or an Asynchronous Transfer Mode (ATM) network) to provide a data communication connection to a compatible LAN. Wireless links can also be implemented. In any such implementation, communication interface 1817 sends and receives electrical, electromagnetic, or optical signals that carry digital data streams representing various types of information. Further, the communication interface 1817 can include peripheral interface devices, such as a Universal Serial Bus (USB) interface, a PCMCIA (Personal Computer Memory Card International Association) interface, etc. Although a single communication interface 1817 is depicted in FIG. 18, multiple communication interfaces can also be employed.

The network link 1819 typically provides data communication through one or more networks to other data devices. For example, the network link 1819 may provide a connection through local network 1821 to a host computer 1823, which has connectivity to a network 1825 (e.g. a wide area network (WAN) or the global packet data communication network now commonly referred to as the “Internet”) or to data equipment operated by a service provider. The local network 1821 and the network 1825 both use electrical, electromagnetic, or optical signals to convey information and instructions. The signals through the various networks and the signals on the network link 1819 and through the communication interface 1817, which communicate digital data with the computer system 1800, are exemplary forms of carrier waves bearing the information and instructions.

The computer system 1800 can send messages and receive data, including program code, through the network(s), the network link 1819, and the communication interface 1817. In the Internet example, a server (not shown) might transmit requested code belonging to an application program for implementing an embodiment of the invention through the network 1825, the local network 1821 and the communication interface 1817. The processor 1803 may execute the transmitted code while being received and/or store the code in the storage device 1809, or other non-volatile storage for later execution. In this manner, the computer system 1800 may obtain application code in the form of a carrier wave.

The term “computer-readable medium” as used herein refers to any medium that participates in providing instructions to the processor 1803 for execution. Such a medium may take many forms, including but not limited to non-volatile media, volatile media, and transmission media. Non-volatile media include, for example, optical or magnetic disks, such as the storage device 1809. Volatile media include dynamic memory, such as main memory 1805. Transmission media include coaxial cables, copper wire and fiber optics, including the wires that comprise the bus 1801. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

FIG. 19 illustrates a chip set 1900 upon which an embodiment of the invention may be implemented. Chip set 1900 is programmed to securely transmit payments from mobile devices lacking a physical TSM and includes, for instance, the processor and memory components described with respect to FIG. 19 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1900, or a portion thereof, constitutes a means for performing one or more steps of FIGS. 14-17.

In one embodiment, the chip set 1900 includes a communication mechanism such as a bus 1901 for passing information among the components of the chip set 1900. A processor 1903 has connectivity to the bus 1901 to execute instructions and process information stored in, for example, a memory 1905. The processor 1903 may include one or more processing cores with each core configured to perform independently. A multi-core processor enables multiprocessing within a single physical package. Examples of a multi-core processor include two, four, eight, or greater numbers of processing cores. Alternatively or in addition, the processor 1903 may include one or more microprocessors configured in tandem via the bus 1901 to enable independent execution of instructions, pipelining, and multithreading. The processor 1903 may also be accompanied with one or more specialized components to perform certain processing functions and tasks such as one or more digital signal processors (DSP) 1907, or one or more application-specific integrated circuits (ASIC) 1909. A DSP 1907 typically is configured to process real-world signals (e.g., sound) in real time independently of the processor 1903. Similarly, an ASIC 1909 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1903 and accompanying components have connectivity to the memory 1905 via the bus 1901. The memory 1905 includes both dynamic memory (e.g., RAM, magnetic disk, writable optical disk, etc.) and static memory (e.g., ROM, CD-ROM, etc.) for storing executable instructions that when executed perform the inventive steps described herein to controlling a set-top box based on device events. The memory 1905 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
providing an online product catalog framework, wherein the online product catalog framework includes a catalog management module, a pricing engine, a content management module, and a profile management module;
managing the catalog management module, the pricing engine, and the content management module separately; and
generating a personalized product catalog by using one or more rules-based targeters, one or more rules-based templates, or a combination thereof with the catalog management module, the pricing engine, the content management module, the profile management module, or a combination thereof.

2. The method according to claim 1, further comprising:
causing a presentation of the personalized product catalog on one or more device types across one or more commerce channels based on profile information, order information, content information, or a combination thereof.

3. The method according to claim 2, further comprising:
determining the profile information, the order information, or a combination thereof based on one or more inputs by one or more customers; and
determining the content information via the content management module based on one or more inputs by one or more business users.

4. The method according to claim 1, further comprising:
causing at least one presentation of the personalized product catalog in at least one staging commerce environment associated with the content management module for verification by the one or more business users; and
causing at least one deployment of the personalized product catalog in at least one production commerce environment associated with the content management module based on the verification,
wherein the personalized product catalog is further based on one or more incremental batch feeds from one or more product catalog systems.

5. The method according to claim 1, wherein at least one hierarchy of the personalized product catalog is based on one or more content items associated with one or more categories including phone, internet, television, bundles, applications, equipment, or a combination thereof, and wherein the one or more content items are further organized based on one or more categories including learning-related content, ordering-related content, account and services-related content, support-related content, or a combination thereof.

6. The method according to claim 1, further comprising:
determining at least one modification of the one or more rules, one or more tables, one or more templates, or a combination thereof associated with the online product catalog framework; and
causing at least one update of the personalized product catalog based on the at least one modification,
wherein the presentation of the personalized product catalog is further based on the at least one update.

7. The method according to claim 1, wherein the one or more rules-based targeters, the one or more rules-based templates, or a combination thereof are based on (1) the profile information, the order information, or a combination there; (2) one or more inputs by the one or more business users; or (3) a combination thereof.

8. The method according to claim 1, wherein the online product catalog framework is based on at least two data centers, each including one or more commerce servers, at least one content management server, one or more database servers, or a combination thereof.

9. A method comprising:
determining pricing data based on one or more customer sales zones; and
determining one or more data feeds based on one or more product catalog systems,
wherein a pricing engine causes a generation of a personalized product catalog based on the pricing data, the one or more data feeds, or a combination thereof.

10. The method according to claim 9, wherein the pricing data includes one or more prices, one or more discounts, one or more bundle prices, or a combination thereof based on one or more droplets, one or more tables, or a combination thereof.

11. An apparatus comprising:
a processor; and
a memory including computer program code for one or more programs,
the memory and the computer program code configured to, with the processor, causing to perform at least the following,
provide an online product catalog framework, wherein the online product catalog framework includes a catalog management module, a pricing engine, a content management module, and a profile management module;
manage the catalog management module, the pricing engine, and the content management module separately; and
generate a personalized product catalog by using one or more rules-based targeters, one or more rules-based templates, or a combination thereof with the catalog management module, the pricing engine, the content management module, the profile management module, or a combination thereof.

12. The apparatus according to claim 11, further comprising:
cause a presentation of the personalized product on one or more device types across one or more commerce channels based on profile information, order information, content information, or a combination thereof.

13. The apparatus according to claim 12, further comprising:
determine the profile information, the order information, or a combination thereof based on one or more inputs by one or more customers; and
determine the content information via the content management module based on one or more inputs by one or more business users.

14. The apparatus according to claim 11, further comprising:
cause at least one presentation of the personalized product catalog in at least one staging commerce environment associated with the content management module for verification by the one or more business users; and
cause at least one deployment of the personalized product catalog in at least one production commerce environment associated with the content management module based on the verification,
wherein the personalized product catalog is further based on one or more incremental batch feeds from one or more product catalog systems.

15. The apparatus according to claim 11, wherein at least one hierarchy of the personalized product catalog is based on one or more content items associated with one or more categories including phone, internet, television, bundles, applications, equipment, or a combination thereof, and wherein the one or more content items are further organized based on one or more categories including learning-related content, ordering-related content, account and services-related content, support-related content, or a combination thereof.

16. The apparatus according to claim 11, further comprising:
determine at least one modification of the one or more rules, one or more tables, one or more templates, or a combination thereof associated with the online product catalog framework; and
cause at least one update of the personalized product catalog based on the at least one modification,
wherein the presentation of the personalized product catalog is further based on the at least one update.

17. The apparatus according to claim 11, wherein the one or more rules-based targeters, the one or more rules-based templates, or a combination thereof are based on (1) the profile information, the order information, or a combination there; (2) one or more inputs by the one or more business users; or (3) a combination thereof.

18. The apparatus according to claim 11, wherein the online product catalog framework is based on at least two data centers, each including one or more commerce servers, at least one content management server, one or more database servers, or a combination thereof.

19. An apparatus comprising:
a processor; and
a memory including computer program code for one or more programs,
the memory and the computer program code configured to, with the processor, causing to perform at least the following,
determine pricing data based on one or more customer sales zones; and
determine one or more data feeds based on one or more product catalog systems,
wherein a pricing engine causes a generation of a personalized product catalog based on the pricing data, the one or more data feeds, or a combination thereof.

20. The apparatus according to claim 19, wherein the pricing data includes one or more prices, one or more discounts, one or more bundle prices, or a combination thereof based on the one or more droplets, the one or more tables, or a combination thereof.
